(19) United States
(12) Patent Application Publication
(10) Pub. No.: US 2005/0023234 A1
(43) Pub. Date: Feb. 3, 2005

(54) Clip-on taco holder

(76) Inventor: Steven G. Head, Joplin, MO (US)

Correspondence Address: JEFFREY SONNABEND, 441 FIRST STREET, SUITE 1L, BROOKLYN, NY, 11215, US

(21) Appl. No.: 10/887,395

(22) Filed: Jul. 8, 2004

Related U.S. Application Data
(60) Provisional application No. 60/491,067, filed on Jul. 30, 2003.

(51) Int. Cl. A47F 7/00; A23B 4/00; A21D 10/02; B65D 85/00

(52) U.S. Cl. 211/85.4

(57) ABSTRACT

This invention is a holder for up to three (3) or more tacos which clips onto the edge of most any typical dinner or serving plate. This holder for taco shells is designed to hold the tacos in an upright position for filling the taco ingredients, and keeping them upright to avoid the taco ingredients from spilling out as well as giving outside support with filling the taco, thereby helping to avoid breaking the taco shell.

### CROSS-REFERENCE TO RELATED APPLICATIONS

This application claims the benefit of U.S. Provisional Application No. 60/491,067 filed on Jul. 30, 2003.

### BACKGROUND OF THE INVENTION

1. Field of the Invention

The present invention relates generally to food holders and more specifically to the field of hard-shell tacos and similar food items.

2. Background of the Related Art

The taco, recognized as a Mexican food item, consists of a folded tortilla with several ingredients, the most common of which are seasoned ground beef, chopped lettuce, shredded cheese, chopped onions and usually a Taco Sauce. Other condiment items can also be used. The Taco shell can be soft or hard. The soft Taco is usually eaten with a knife and fork, whereas the hard Taco is picked up and eaten by hand.

The biggest problem serving or eating the hard Taco, is that it cannot stand upright on it's own, thereby easily spilling the contents out. Also the shell is brittle and can easily break when filling the ingredients.

Our taco holder invention is designed to remedy the spillage and breakage problem in a simple—but very effective way.

### SUMMARY OF THE INVENTION

The subject invention is directed to a new and useful clip-on taco holder.

This taco holder invention is an example of simplicity at it's best. Not only does this invention hold the taco shell upright for filling the ingredients and for resting a partially-eaten taco between bites—but also clips to the edge of the dinner plate for resistance to tipping-over while carrying the plate between the table and kitchen, buffet lines, or passing back and forth between people. Other holders of this type are bulkier, heavier or free-standing, (able to tip over).

Measuring approximately six (6) inches long, two (2) inches tall and one and one-half inches wide, this Taco Holder is made from one (1) formed piece of material that is approximately 1/8th inches thick. Although this taco holder invention can be made of various materials, we designed it with molded plastic in mind as the primary material of manufacture.

Embodiments of the instant invention may have a clip area and a food receptacle area wherein the clip area has an upper retention surface and a lower retention surface. The upper and lower retention surfaces may define a plate receptacle therebetween, and the lower retention surface may be biased towards the upper retention surface such that upon insertion of a plate into the plate receptacle, the lower retention surface secures the plate between the upper and lower retention surfaces. The food receptacle area may have at least one food receptacle for operatively receiving a food item, and each of the food receptacles may have a seat portion and at least two side portions.

In certain embodiments of the present invention, each of the side portions may include a lower portion defining an angle of approximately between 45 and 75 degrees relative to the seat portion and an upper portion defining an angle of approximately between 75 and 90 degrees relative to the seat portion. Each side portion may terminate in an apex opposite from the seat portion.

The clip area may include an extension portion for positioning the food receptacle area substantially over the center of a plate. The food receptacle area may include a stabilizing foot.

The clip-on food holder may be approximately six inches long as measured from the stabilizing foot to the clip portion.

These and other aspects of the subject invention will become more readily apparent to those having ordinary skill in the art from the following detailed description of the invention taken in conjunction with the drawings described herein.

### BRIEF DESCRIPTION OF THE DRAWINGS

So that those having ordinary skill in the art to which the subject invention pertains will more readily understand how to make and use the subject invention, preferred embodiments thereof will be described in detail herein with reference to the drawings.

FIG. 1 is an isometric view of a preferred embodiment of this invention.

FIG. 2 is a front-left side elevation view.

FIG. 3 is a front-right side elevation view.

FIG. 4 is a end view (foot).

FIG. 5 is a end view (clip).

### DETAILED DESCRIPTION OF THE PREFERRED EMBODIMENTS

Referring now in detail to the drawings wherein like reference numerals identify similar structural features of the several embodiments of the subject invention, there is illustrated in the several figures a preferred embodiment of the present invention.

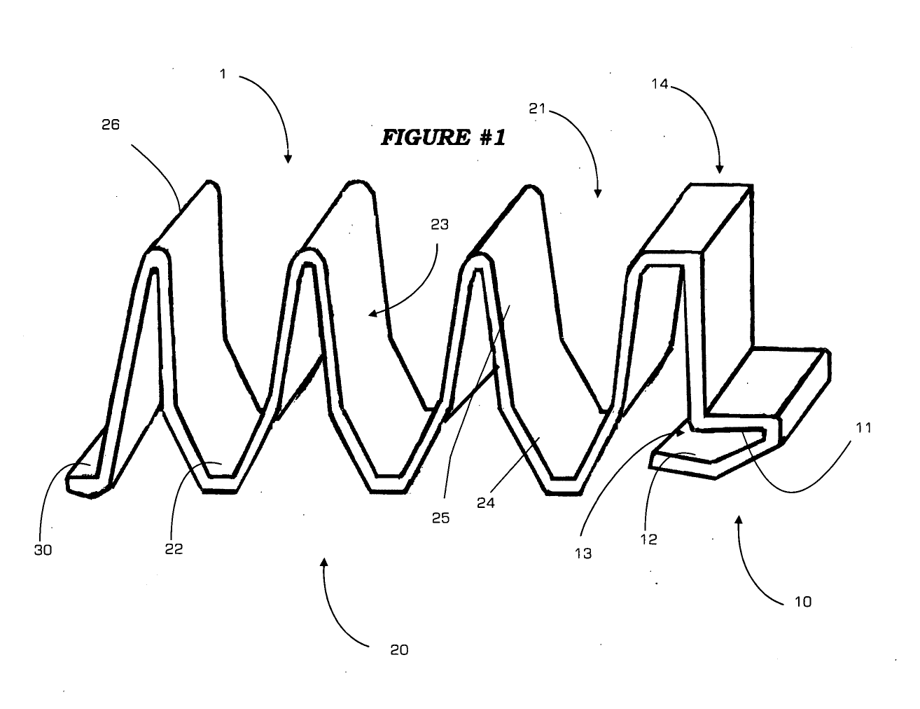

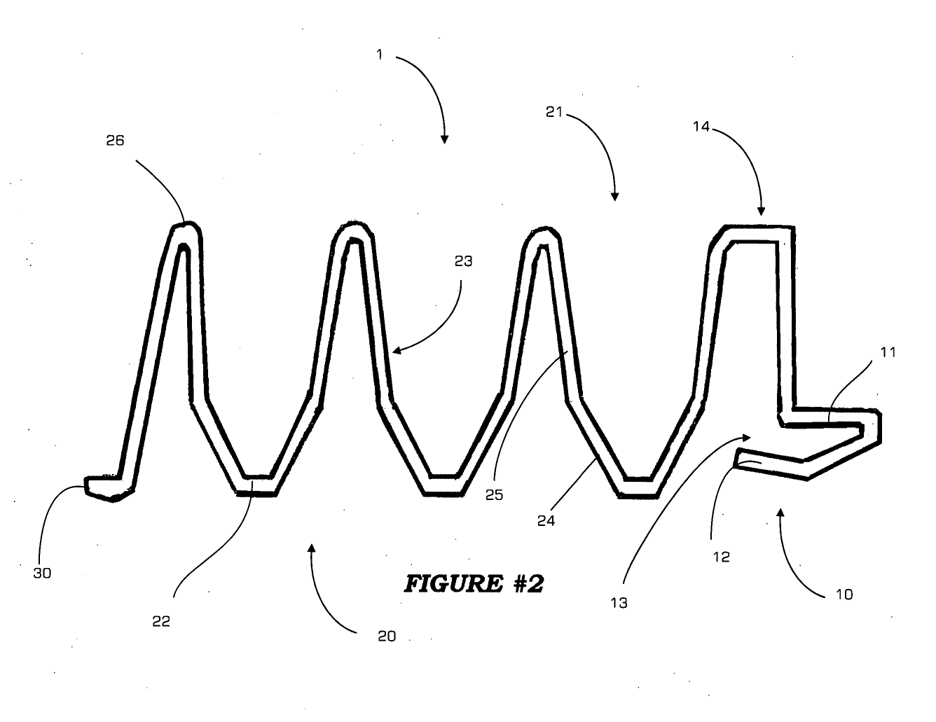

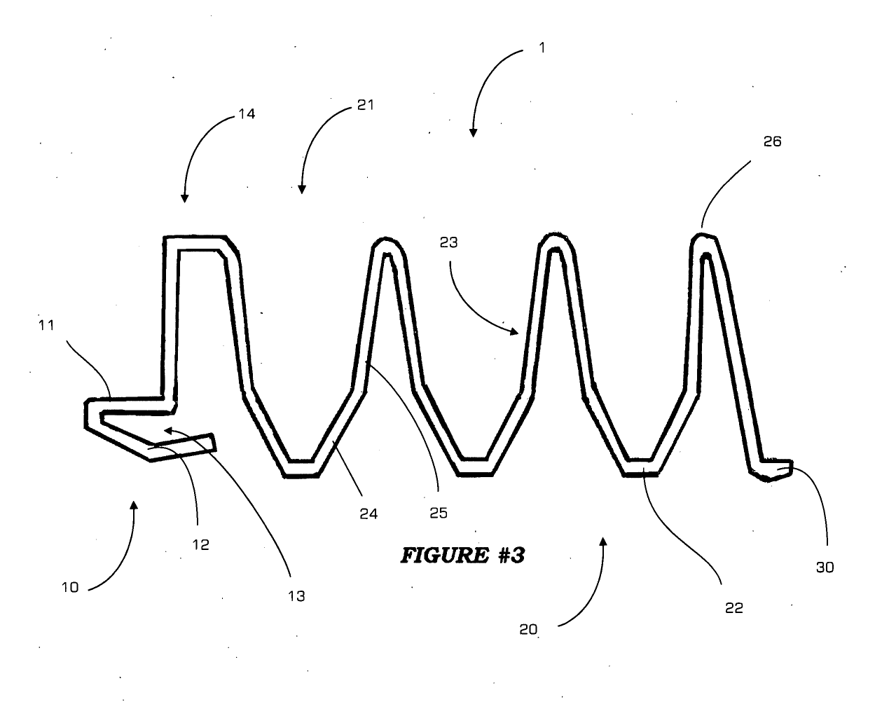

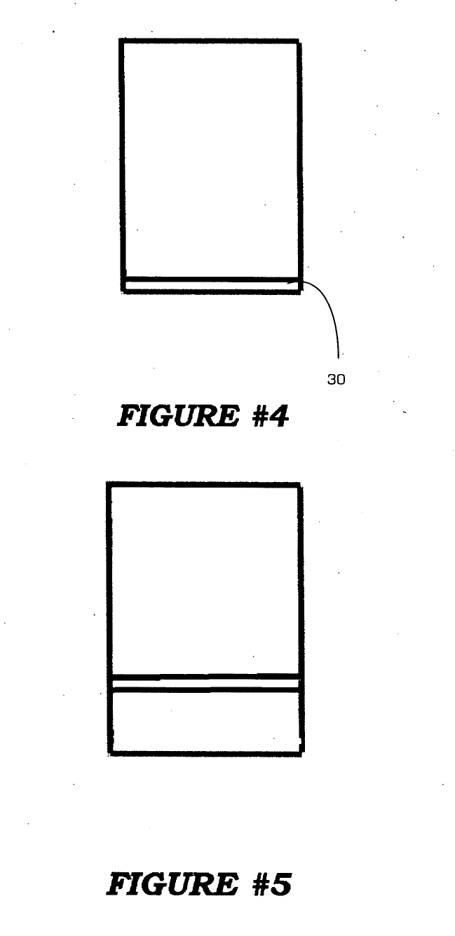

Referring for instance to FIG. 1, clip-on taco holder 1 includes clip area 10 and food receptacle area 20. Clip area 10 includes upper retention surface 11 and lower retention surface 12 which define plate receptacle 13. In operation, clip-on taco holder 1 is attached to a plate (not shown) which is inserted into plate receptacle 13. The plate deforms or otherwise forces lower retention surface 12 away from upper retention surface 11, thereby clamping clip-on taco holder 1 to the plate. Any deformation or other forcing away of lower retention surface 12 may be plastic in nature so that upon removal of a plate from plate receptacle 13, lower retention surface 12 returns to its resting position, which may be biased towards upper retention surface 11.

Clip area 10 includes extension portion 14 which provides adequate spacing between the rim of a plate inserted into clip area 10 and food receptacle area 20; that is, extension portion 14 ensures that food receptacle area 20 is positioned substantially over the center of an attached plate as opposed to resting on a rim of such a plate.

As used herein, “plate” may include any food carrier, including among others plates and trays.

Food receptacle area 20 includes food receptacles 21. Each food receptacle 21 includes a seat portion 22 and side portions 23. Food receptacle area 20 includes a stabilizing foot 30 at its end. Each food receptacle 21 is adapted for receiving a food item such as a hard or soft shell taco, pita bread sandwich or the like. Seat portions 22 and side portions 23 are adapted to ensure that food items placed in food receptacle area 20 are maintained within that area.

Side portions 23 include lower portions 24 and upper portions 25. Each lower portion 24 defines an angle of approximately between 45 and 75 degrees relative to seat portion 22. Each upper portion 25 defines an angle of approximately between 75 and 90 degrees relative to seat portion 22. Each side portion 23 terminates at its upper end, which is substantially opposite seat portions 22, in an apex 26.

While particular embodiments of the present invention have been shown and described, it will be apparent to those skilled in the pertinent art that changes and modifications may be made without departing from the invention in its broader aspects.

1. A clip-on food holder comprising:
a clip area and a food receptacle area;
said clip area having an upper retention surface and a lower retention surface, said upper and lower retention surfaces defining a plate receptacle therebetween, said lower retention surface being biased towards said upper retention surface such that upon insertion of a plate into said plate receptacle said lower retention surface secures said plate between said upper and lower retention surfaces;
said food receptacle area having at least one food receptacle for operatively receiving a food item, each of said food receptacles having a seat portion and at least two side portions.

2. The clip-on food holder of claim 1 wherein:
each of said side portions includes a lower portion defining an angle of approximately between 45 and 75 degrees relative to said seat portion and an upper portion defining an angle of approximately between 75 and 90 degrees relative to said seat portion; and
each of said side portions terminates in an apex substantially opposite from said seat portion.

3. The clip-on food holder of claim 2 wherein said clip area includes an extension portion for position said food receptacle area substantially over the center of said plate.

4. The clip-on food holder of claim 2 wherein said food receptacle area includes a stabilizing foot.

5. The clip-on food holder of claim 4 wherein said clip on foot holder is approximately six inches long as measured from said stabilizing foot to said clip portion.

6. A clip-on food holder comprising:
means for operatively attaching said clip-on food holder to a plate; and
a food receptacle area operatively adapted for accepting and holding food items, said food receptacle area having seat means and side portion means.
